(19) United States
(12) Patent Application Publication
(10) Pub. No.: US 2024/0299136 A1
(43) Pub. Date: Sep. 12, 2024

(54) PLASTIC SPLINTS OR ALIGNERS FOR USE IN THE TREATMENT OF MALOCCLUSIONS BASED ON FORCE MEASUREMENT

(71) Applicants: DENTSPLY SIRONA Inc., York, PA (US); SIRONA DENTAL SYSTEMS GMBH, Bensheim (DE)

(72) Inventors: Christoph BRANDES, Mannheim (DE); Jonathan Merlin VAN KEMPEN, Bensheim (DE)

(73) Assignee: DENTSPLY SIRONA Inc., York, PA (US)

(21) Appl. No.: 18/576,539

(22) PCT Filed: Jul. 4, 2022
(86) PCT No.: PCT/EP2022/068429

§ 371 Date: Jan. 4, 2024

(30) Foreign Application Priority Data
Jul. 5, 2021 (EP) 21183816.4
Jul. 5, 2021 (EP) 21183818.0

(51) Int. Cl. A61C 7/08; A61C 19/04

(52) U.S. Cl. CPC A61C 7/08; A61C 19/04; A61C 2201/002

(57) ABSTRACT

An aligner for use in the treatment of malocclusions/misalignments by using force measurement of the aligner on the teeth. The aligner has at least two referencing features located on it in the initial state. The referencing features are of such a size, about or at least 10 micrometers, that they can be accurately detected by a camera or other means. The referencing features are of an optical or topographic kind.

The entire content of the priority applications EP21183818.0 and EP21183816.4 are hereby incorporated by reference to this international application under the provisions of the PCT.

### TECHNICAL FIELD OF THE INVENTION

The present invention relates to orthodontic treatment methods, in particular to the treatment of malocclusions/misalignments through plastic splints or to aligner therapy.

### BACKGROUND OF THE INVENTION

Aligner therapy is an orthodontic treatment method for the largely invisible treatment of mild to severe tooth misalignments that works with a sequence of individually manufactured, thin and transparent plastic splints (“aligner”). The plastic aligners are manufactured by deep drawing thermoform foils or by additive manufacturing processes such as 3D printing.

For the success of the therapy, it is necessary that the aligners apply a sufficiently high force on the tooth. In the course of wearing the aligner, the plastic material from which the aligner was manufactured deforms. As a result, the force applied to the tooth is reduced and an effective therapy can no longer be guaranteed. Therefore, the dentist uses a new aligner at regular intervals so that the therapy can be continued successfully.

It is important for the effectiveness of the therapy that the aligners are of consistent quality over the duration of use, as possible.

### DISCLOSURE OF THE INVENTION

Currently, the inventors are not aware of any prior art with which the doctor/patient can easily determine the effectiveness of the treatment, track the progress of the treatment and, for example, determine the time for changing to a new aligner.

An objective of the present invention is to provide an aligner that can be used to determine the effectiveness of the therapy and to track the progress of the therapy.

Another objective of the present invention is to provide a method for measuring in vivo or ex vivo the force of aligners to determine the effectiveness of the therapy and to track the progress of the therapy.

These objectives have been achieved by the aligner of claim 1, and the method of claim 2. The subject-matters of the dependent claims relate to further developments and preferred embodiments.

The aligner according to the invention are provided for use in the treatment of malocclusions/misalignments, wherein the use comprises force measurement of the aligner on the teeth. In the initial state, there are at least two referencing features on the aligner. These referencing features are large enough to be accurately detected by a camera or other means. The referencing features are optical and or topographic in nature. The referencing features may be located on the inside and/or outside of the aligner. Optical features can be colored markings or contrast differences. Topographic features can be elevations or depressions or regular structures on the surface. Optical and topographic features are approximately or at least 10 μm in size, or preferably 10 μm to 100 μm in size, or preferably 10 μm to 1000 μm in size. These may preferably include microlenses and/or microreflectors.

The method according to the invention for measuring the force of aligners comprises the following steps: Providing the force/displacement curves of the plastic of the aligner in the initial state; determining the displacement of the at least two referencing features from each other relative to the initial state due to the application of force during the wearing of the aligner by the patient, by means of a recording obtained through a camera or another suitable means, e.g. for optical measurement; calculating the forces acting on the tooth by converting the determined displacement via the provided force/displacement curve.

According to the present invention, it is possible to determine the force applied to the tooth by aligners, or to determine whether the minimum necessary force is applied to the tooth. The necessary forces per tooth can differ due to the biology and the desired displacement. However, the targeted forces are always in the range between 0.05 N and 5 N.

According to the present invention, it is also possible to determine how the force on the teeth changes in the course of wearing the aligner or to determine whether the force on the teeth falls below a necessary limit value in the course of wearing the aligner. The force can be determined very locally.

Wearing aligners for a long time causes them to lose their internal tension. That means, deformations and thus the displacement of the referencing features are irreversible. Another embodiment focuses on detecting this type of irreversible deformations in order to determine the change timing of the aligner. Therefore, in a further embodiment, the method comprises the steps of determining the displacement of the at least two referencing features from each other due to the application of force, relative to the initial state after removal of the aligner, by means of recording obtained through a camera or other tool; and calculating the forces that would act on the tooth by converting the determined displacement via the force/displacement curve provided.

In accordance with the present invention, this further enables the physician/patient to have the time of change displayed using a simple tool, e.g., a mobile phone camera & an app or an intraoral camera such as Primescan & and related software.

### BRIEF DESCRIPTION OF THE DRAWINGS

In the following description, the present invention will be explained in more detail by means of embodiment with reference to the drawings, whereby

FIG. 1—shows a schematic representation of a brace according to a comparative embodiment of the invention;

FIG. 2—shows a schematic representation of an aligner from above according to one embodiment of the invention;

FIG. 3—shows a schematic representation of an aligner from the front according to one embodiment of the invention.

The reference numbers shown in the drawings designate the elements listed below, which are referred to in the following description of the exemplary embodiments.
1. Brace
1a. Wire
1b. Referencing feature
2. Aligner/Plastic splint
2a. Plastic
2b. Referencing feature

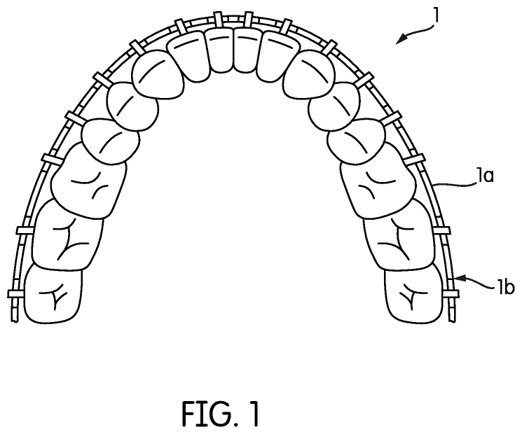

FIG. 1 shows, according to a comparative embodiment, a brace (1) for use in the treatment of malocclusions/misalignments by means of force measurement on the same. In the initial state, there are at least two referencing features (1b) on the wire (1a) of the brace (1). These referencing features (1b) are of such a size that they can be accurately captured in an image obtained through camera or another means. The referencing features (1b) are optical or topographical in nature. The number of referencing features (1b) may also be more than two.

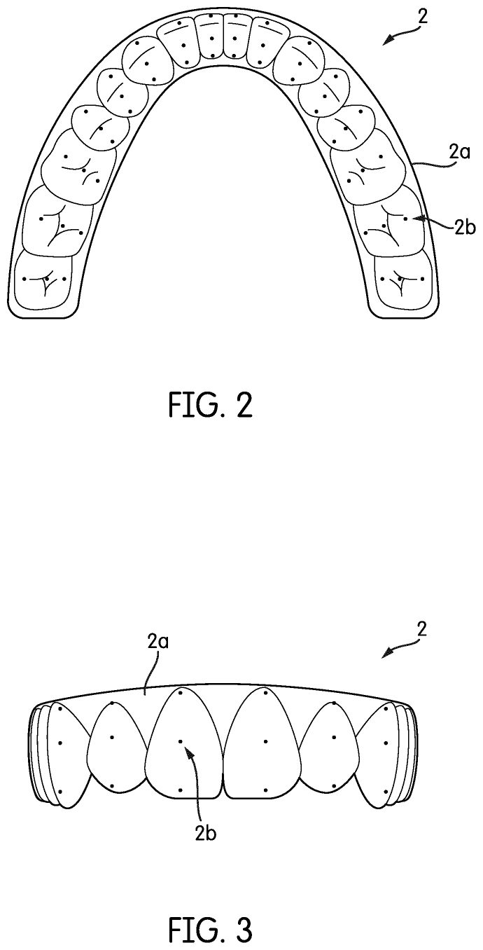

FIG. 2 and FIG. 3 show, according to one embodiment of the present invention an aligner (2) for use in the treatment of tooth malocclusions/misalignments through force measurement on the same. In the initial state, at least two referencing features (2b) are located on the plastic (2a) of the aligner (2). These referencing features (2b) are large enough to be accurately detected by a camera or another means. The referencing features (2b) are optical or topographical in nature. The number of referencing features (1b) may also be more than two.

Preferably, the marking of the referencing features (1b; 2b) of the wire (1) or the aligner (2) can be realized with a laser. This allows precise markings in the micrometer range to be applied to the wire (la) and the plastic (2a).

In the subsequent description, the method for measuring the force of braces (1) or aligners (2) are explained in detail below. The realization of the procedure requires the provision of a marked brace (1) or marked aligner (2) as well as the determination of the displacements and the evaluations.

The application of force when wearing the brace (1) or the aligner (2) causes these referencing features (1b; 2b) to shift from each other. The displacement can be converted into a force via the force/displacement curve of the material. This makes it possible to calculate the forces acting on the tooth. For this purpose, the force/displacement curves of the wire (1) of the brace (1) or the plastic (2a) of the aligner (2) used are predetermined. The force/displacement curve is a material-specific property. However, the thickness of the aligner (2) or the wire (la) is used in the subsequent calculation of the force.

Wearing aligners (2) for a longer period of time causes them to lose their internal tension. This means that deformations and thus the displacement of the referencing features (2b) are irreversible. Thereby even after the aligner (2) has been removed, it is possible to determine which forces have acted and whether the aligner (2) is still able to apply sufficient force to the teeth.

The measurement and evaluation of the data are preferably programmed as a software solution.

In accordance with the present invention, the data sets generated by the method may be presented to a physician for visualization, particularly for therapeutic diagnostic purposes, preferably by means of a screen or printout.

The method according to the invention is a computer-implemented method and can be executed on a computer-assisted intraoral imaging device. To this end, the present invention also includes a computer program having computer-readable code. The computer program may be provided on a data storage device. The computer-assisted intraoral imaging device includes a camera to provide the patient image. The computer-assisted intraoral imaging device further comprises a computer or computing unit connectable to the camera. The computer may be connectable to the camera locally or, alternatively, via the internet. The computing steps may take place locally or in the cloud. The computer or computing unit executes the computer program and provides the data sets, inter alia for visualization on a display. The computerized intraoral imaging device further preferably comprises a display to visualize the data sets to a clinician. The intraoral imaging device preferably comprises a mobile phone camera & app, or an intraoral camera such as the Primescan & the related software.

1. An aligner for use in the treatment of malocclusions/misalignments based on force measurement of the aligner on the teeth, comprising:
at least two referencing features located on the aligner in the initial state,
said referencing features being of such a size of at least 10 micrometers, that they are accurately detected,
said referencing features being of an optical or topographic kind.

2. A method of force measurement of the aligner according to claim 1, comprising:
providing force/displacement curves of the plastic of the aligner in the initial state;
determining a displacement of the at least two referencing features from each other relative to the initial state due to the application of force while the aligner is being worn by a patient using an image acquired by a camera;
calculating forces acting on the tooth by converting the determined displacement via the provided force/displacement curve and the known geometry of the plastic.

3. The method of claim 2, further comprising:
determining the displacement of the at least two referencing features from each other due to the application of force, relative to the initial state after removal of the aligner, by recording through a camera;
calculating the forces acting on the tooth by converting the determined displacement via the provided force/displacement curve and the known geometry of the aligner.

4. A non-transitory computer-readable storage medium storing a program, comprising instructions which, when executed by a computer-assisted intraoral imaging device, causes the computer-assisted intraoral imaging device to perform the method of claim 2.

5. A system for force measurement of the aligner according to claim 1, the system comprising:
a processor; and
a camera;
wherein the processor is configured to:
provide force/displacement curves of the plastic of the aligner in the initial state;
determine a displacement of the at least two referencing features from each other relative to the initial state due to the application of force while the aligner is being worn by a patient using an image acquired by a camera;
calculating forces acting on the tooth by converting the determined displacement via the provided force/displacement curve and the known geometry of the plastic.

6. The system according to claim 5, further comprising:
a mobile phone and
a software application.

7. (canceled)

8. The aligner of claim 1, wherein said referencing feature are detected by a camera.
